(19) United States
(12) Patent Application Publication
(10) Pub. No.: US 2004/0135051 A1
(43) Pub. Date: Jul. 15, 2004

(54) Book page holder

(76) Inventor: Edward J. Rupnick, Renton, WA (US)

Correspondence Address: Charles J. Rupnick, PO Box 46752, Seattle, WA, 98146, US

(21) Appl. No.: 10/743,164

(22) Filed: Dec. 22, 2003

Related U.S. Application Data
(60) Provisional application No. 60/455,351, filed on Mar. 17, 2003.
(60) Provisional application No. 60/439,664, filed on Jan. 13, 2003.

(51) Int. Cl. B42D 3/00

(52) U.S. Cl. 248/451; 281/42

(57) ABSTRACT

A book page holder device for holding open the pages of a book, the book page holder device having a substantially flat and rigid support member that is sized wider than either a standard sized hard cover book in an open state or a standard sized paperback book in an open state. The support member is formed with two passages spaced apart across its width at a distance that is approximately a width of the open hard cover or paperback book. The book page holder also has an elongated resilient elastic retainer having first and second anchors provided adjacent to respective first and second opposite ends thereof. The elastic retainer is structured to pass through the two spaced-apart passages in the support member, while the anchors are structured to be unable to pass through the same two passages.

This application claims the benefit of U.S. Provisional Application Serial No. 60/455,351 filed on Mar. 17, 2003, and of U.S. Provisional Application Serial No. 60/439,664 filed on Jan. 13, 2003, both filed in the name of Edward J. Rupnick, who is the inventor of the present invention, the complete disclosures of which are incorporated herein by reference.

### FIELD OF THE INVENTION

The present invention relates to book holding devices and methods, and in particular to devices and methods for holding open the pages of a book and further for marking a place in a book.

### BACKGROUND OF THE INVENTION

It is well known that the bindings and pages of books, especially new books, are stiff and tend to close unless held open by the reader. For different reasons the reader may not wish to hold the book open, or even to hold the book at all. For example, the reader's hands may tire with the effort of holding the book open. In another example, the reader may wish to read or otherwise view with hands free to do something else while reading or viewing the book.

Many devices and methods are known for holding open the pages of a book, some even hold the book for the reader. However, most of the known devices are complicated, heavy and cumbersome, both to handle and to use.

### SUMMARY OF THE INVENTION

A book page holder device for holding open the pages of a book, the book page holder device having a substantially flat and rigid support member that is sized wider than either a standard sized hard cover book in an open state or a standard sized paperback book in an open state. The support member is formed with two passages spaced apart across its width at a distance that is approximately a width of the open hard cover or paperback book. The book page holder also has an elongated resilient elastic retainer having first and second anchors provided adjacent to respective first and second opposite ends thereof. The elastic retainer is structured to pass through the two spaced-apart passages in the support member, while the anchors are structured to be unable to pass through the same two passages.

According to one aspect of the invention, the support member is formed of an elongated bar having the two spaced-apart passages positioned adjacent to opposite first and second ends of the elongated bar.

According to another aspect of the invention, the support member is formed of a material selected from the group of plastic, Plexiglas, acrylic, wood, and metal materials.

According to another aspect of the invention, the support member is formed of a rectangular plate having the two spaced-apart passages positioned adjacent to opposite first and second side edges of the rectangular plate.

According to another aspect of the invention, at least one of the two spaced-apart passages in the support member is formed as a slot through a thickness of the support member and communicating with an edge thereof.

According to another aspect of the invention, at least one of the two spaced-apart passages in the support member is formed as an aperture formed through a thickness of the support member and positioned adjacent an edge thereof.

According to another aspect of the invention, the elastic retainer is an elastic fabric covered with cloth and having the anchoring means formed at first and second opposite ends thereof.

According to still another aspect of the invention, the first and second anchors are any one of a loop, a knot, a slip-on clip, and a crimp-on clip.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates the present invention embodied as a book page holder;

FIGS. 2A and 2B illustrate one embodiment of the invention wherein FIG. 2A is a plan view of a support bar portion of the invention, and FIG. 2B is an end view of the support bar portion;

FIGS. 3 and 4 illustrate the elastic retainer anchors alternatively embodied as different external members fitted to the elastic retainer of the present invention as illustrated in FIG. 1, wherein FIG. 3 illustrates the anchors embodied as mechanical slip-on clips formed of thin flat disks, and FIG. 4 illustrates the anchors embodied as two different mechanical crimp-on clips;

FIGS. 5, 6, and 7 together illustrate initial installation of the book page holder of the invention, wherein FIG. 5 illustrates initial preparation of the book page holder, FIG. 6 illustrates the book page holder positioned under an open book with the elastic retainer poised to capture the pages of the book in an open configuration, and FIG. 7 illustrates the body of the elastic retainer stretched over the open pages of the book;

FIGS. 8, 9 and 10 illustrate an alternative method of turning pages while using the book page holder of the invention, wherein FIG. 8 illustrates initial preparation of the book page holder for turning the pages of the book, FIG. 9 illustrates the book page holder of the invention during turning of the pages of the book, and FIG. 10 illustrates re-anchoring of the elastic retainer after turning of the pages of the book;

FIGS. 11, 12 and 13 together illustrate operation of the book page holder of the invention for marking a place in the book when not in use for holding the book open, wherein FIG. 11 illustrates initial preparation of the book page holder for operating as a book mark,

FIG. 12 illustrates an intermediate phase of operation of the book page holder as a book mark with the support bar portion aligned with the book's spine and the elastic retainer portion lying between the pages to be marked, and FIG. 13 illustrates the book page holder of the invention with the book closed over the retainer portion between the pages to be marked;

FIGS. 14, 15 and 16 each illustrate one or more alternative embodiments of the support bar portion of the book page holder of the invention, wherein FIG. 14 illustrates the support bar portion embodied as an elongated bar having different slots formed through the substrate thickness of each of the opposite first and second ends, FIG. 15 illustrates the support bar portion embodied as an elongated bar having additional different slots formed through the substrate thickness of each of the opposite first and second ends, and FIG. 16 illustrates yet another alternative embodiment of the invention wherein the support bar portion is configured as a substantially rigid plate with an aperture for anchoring one or both ends of the elastic retainer portion of the book page holder of the invention;

FIG. 17 is a plan view that illustrates another alternative embodiment of the book page holder invention;

FIG. 18 illustrates another alternative embodiment of the book page holder of the invention wherein the support bar is an elongated bar formed with a small notch or indentation in at least one end that is structured to accommodate a hook-shaped anchoring means;

FIG. 19 illustrates another alternative embodiment of the book page holder of the invention wherein the anchoring means is provided as a passage formed through the thickness of the substrate of which the support bar is fabricated;

FIG. 20 illustrates another alternative embodiment of the book page holder of the invention wherein the anchoring means is structured as a hook-shaped members having an open mouth structured with one or more gripping members or “teeth” for anchoring the elastic retainer to an end of the support bar, whereby the slots, apertures and notches of other embodiments of the invention illustrated in other Figures are eliminated;

FIG. 21 illustrates by example and without limitation a telescoping feature of the support bar;

FIG. 22 illustrates the folding book page holder of the invention including a folding feature and configured in an open and locked operating condition in which the hinged support bar supports the open pages of a book on its substantially planar book support surface; and

FIG. 23 illustrates the folding book page holder of FIG. 22 embodied, by example and without limitation, having a hinge mechanism structured as one or a plurality of matching dog-leg portions interconnected by a press-fit hinge pin.

### DETAILED DESCRIPTION OF PREFERRED EMBODIMENT

In the Figures, like numerals indicate like elements.

The present invention is an apparatus and method for holding open the pages of a book and further for marking a place in a book. Accordingly, the book page holder of the invention is embodied in an elongated resilient elastic retainer having first and second anchors at opposite first and second ends thereof; and a substantially rigid support bar formed in the general shape of an elongated rectangle having substantially planar first and second surfaces spaced apart by the thickness of a substrate of which the support bar is formed and having first and second end portions at opposite ends of the elongated rectangle shape and spaced far enough apart to admit an open book therebetween of a standard sized hard cover or paperback book size.

According to one or more embodiments of the invention, each of the first and second end portions is formed with a slot through the substrate thickness and extending a relatively short distance along the longitudinal axis of the rectangular shape with the slots being sized to accept the elastic retainer thereinto and to reject the first and second anchors from entering thereinto and being spaced apart farther than a distance between the first and second anchors when the elastic retainer is configured in a relaxed state. According to one embodiment of the invention, interior ends of the slots are spaced sufficiently far apart to admit therebetween a standard sized hard cover or paperback book in an open state.

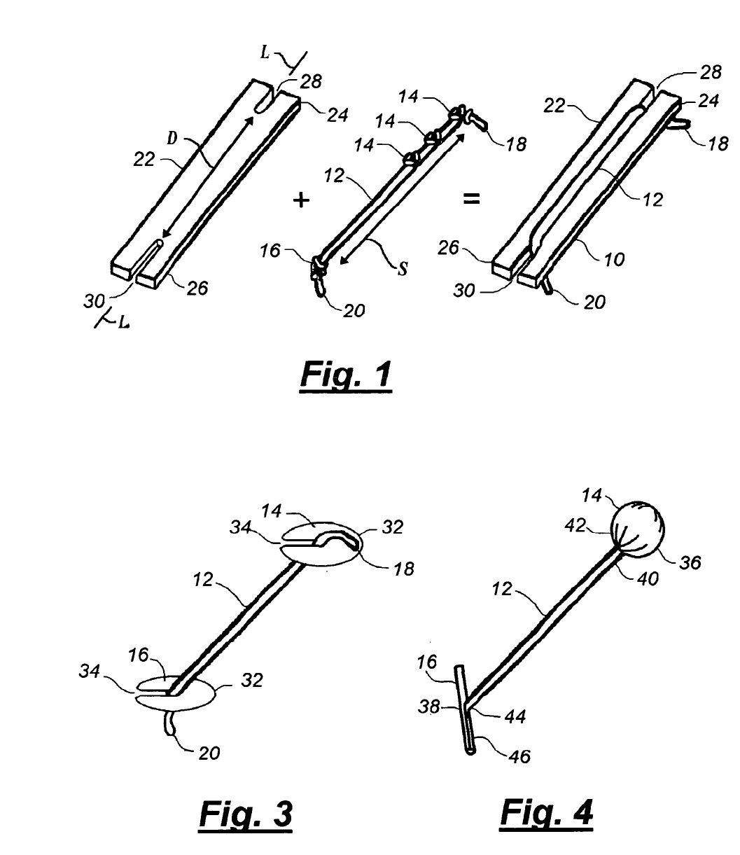

FIG. 1 illustrates the present invention embodied as a book page holder 10 having an elongated resiliently stretchable elastic retainer 12 formed, for example, of an elastic material having a “slippery” contact surface that permits the elastic retainer 12 to slip across pages of the book without sticking, the slippery contact surface is formed with a low coefficient of friction as compared with, for example, a natural or synthetic rubber band. In one example, the low friction slippery contact surface is provided by the resiliently stretchable elastic retainer 12 being formed with a material surface finish having a coefficient of friction that is low as compared with, for example, the surface finish of a common natural or synthetic rubber band. Alternatively, the low friction slippery contact surface is provided by a covering of cloth or other natural or synthetic fabric having such a relatively low coefficient of friction. The elastic retainer 12 is structured with first and second anchors 14, 16 adjacent opposite ends thereof. The anchors 14, 16 are integral enlarged portions of the elastic retainer 12 formed, for example, by sewing, gluing, by knots tied therein (shown), or by other conventional manufacturing process. The anchors 14, 16 are optionally formed by external members fitted to the elastic retainer 12, as described in subsequent figures. The anchors 14, 16 are spaced along the elongated elastic retainer 12 a distance determined to stretch under light hand pressure to a length sized to fit across the open pages of a book. Optionally, the elastic retainer 12 and the distance between the anchors 14, 16 are sized to fit across the open pages of either a standard sized hard cover or paperback book and include the thickness of the pages between the opening and the books covers, as illustrated in subsequent figures. Tails 18, 20 are provided at first and second ends of the elastic retainer 12 distal of the anchors 14, 16. The tails 18, 20 are sized sufficiently long to be grasped by the user's finger and thumb to manipulate the elastic retainer 12 relative to a support bar 22 for holding open the pages of a book and further for marking a place in a book, as described herein.

According to one alternative embodiment of the invention, multiple anchors 14 (or 16) are provided at intervals alone the length of the elastic retainer 12, whereby the book page holder 10 of the invention accommodates books of different thickness from pamphlets of a few pages to tomes of 1,000 pages or more.

The support bar 22 is a substantially rigid bar formed of plastic or Plexiglas, acrylic, wood, metal, or another suitably stiff material. Alternatively, the rigidity of the support bar 22 is supplied by conventional stiffening shapes formed in a thin sheet of plastic or other formable material. For example, the support bar 22 is formed with a plurality of ridges, waffles, curves or other conventional stiffening shapes formed in through a cross-sectional area taken crosswise to the longitudinal axis of the support bar 22. According to one embodiment of the invention, the support bar 22 is formed in the general shape of an elongated rectangle having substantially planar first and second surfaces spaced apart by the thickness of a substrate of which the support bar is formed and having first and second end portions 24, 26 at opposite ends of the elongated rectangle shape. Each of the first and second end portions 24, 26 includes a respective having passages 28, 30 formed, by example and without limitation, as slots formed through the substrate thickness and extending a relatively short distance along the longitudinal axis L of the elongated rectangle shape. The slots 28, 30 are optionally angled relative to the longitudinal axis L or curvilinear in shape, or may include a re-entrant cut as a locking means for the elastic retainer 12, as described in subsequent figures. The slots 28, 30 provide anchorage for the elastic retainer 12 and are sized to accept the elastic retainer 12 thereinto and to reject the first and second anchors 14, 16 from entering thereinto, i.e., the slots 28, 30 are too narrow to permit the anchors 14, 16 to pass. The slots 28, 30 are spaced apart a distance D that is farther than a length S of the elastic retainer 12 between the first and second anchors 14, 16 when the elastic retainer 12 is configured in a relaxed state. For example, according to one embodiment of the invention, interior ends of the slots are spaced sufficiently far apart to admit a standard sized hard cover book therebetween. According to another embodiment of the invention, interior ends of the slots are spaced sufficiently far apart to admit a standard sized paperback book therebetween.

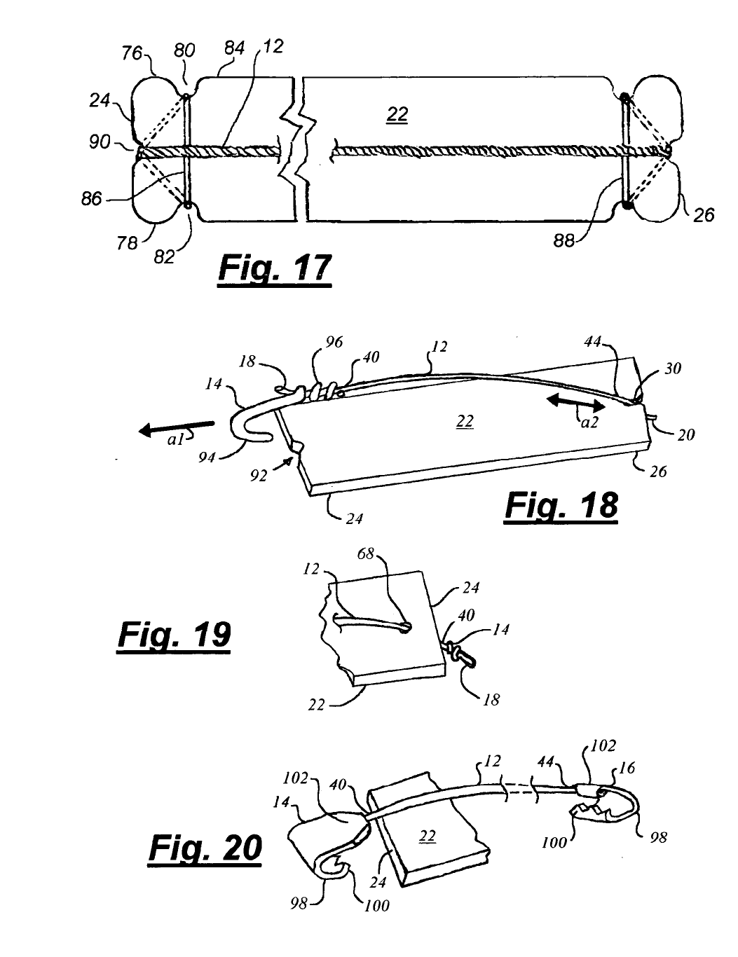

According to one alternative embodiment of the invention illustrated most clearly in FIG. 18, the slots 28, 30 are sized more narrow than the body of the elastic retainer 12 so as to crimp the body thereof when it is pressed into the slots 28, 30 (shown). The tail portions 18, 20 (shown) are left on an opposite side of the support bar 22 from the elastic retainer 12. The elastic retainer anchoring means is thus provided by the slots 28, 30 formed in the support bar 22, whereby anchors 14, 16 are eliminated from the elastic retainer 12.

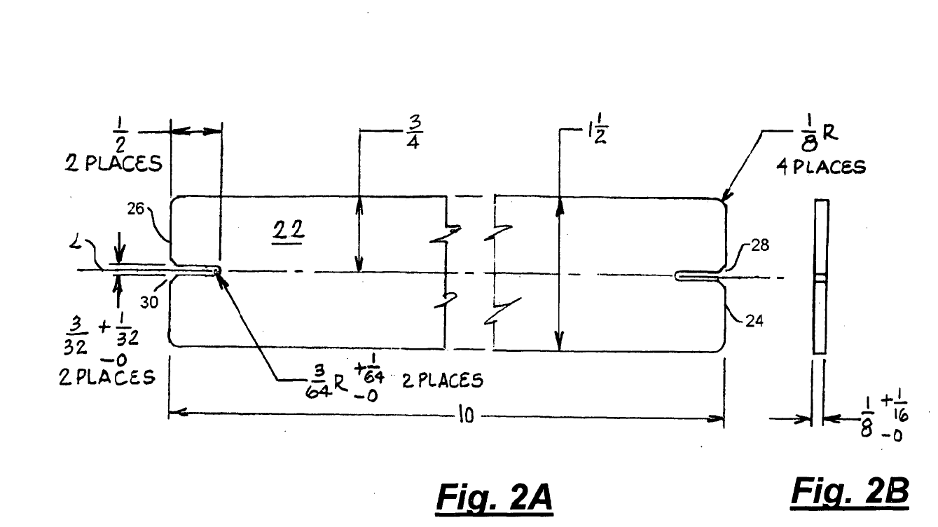

FIG. 2A and FIG. 2B illustrate one embodiment of the invention wherein FIG. 2A is a plan view of the support bar 22, and FIG. 2B is an end view. According to the embodiment illustrated in FIGS. 2A and 2B, the support bar 22 is either transparent, i.e., see through, or opaque, and measures about 10 inches long by about 1 1/2 inches wide and about ⅛ to about 3/16 inches thick. The slots 28, 30 are formed approximately on the longitudinal centerline L of the support bar 22, or about 3/4 inches from one long edge. The slots 28, 30 are about 3/32 to about 1/8 inch wide and measure about 1/2 inch long so that the distance D (shown in FIG. 1) by which the slots 28, 30 are spaced apart is about 9 inches. Each of the slots 28, 30 is formed with a radius in its closed end and a beveled lead-in formed at the entrance or open end where the slot 28, 30 communicates with the edge of the support bar 22. The outside corners of the support bar 22 are beveled or rounded (shown).

FIG. 3 and FIG. 4 illustrate the anchors 14, 16 alternatively embodied as different external members fitted to the elastic retainer 12. Accordingly, in FIG. 3 the anchors 14, 16 are embodied as mechanical slip-on clips formed of thin flat plastic disks 32 each having a slot 34 formed part way through from one edge. The slots 34 are sized more narrow than the body of the elastic retainer 12 so as to crimp the body thereof when it is pressed into the slot 34. The tail portions 18, 20 are left on the outside of the disks 32 away from the main body of the elastic retainer 12. The slots 34 may have a funnel-shaped lead-in at the disk edge for ease of slipping the end of the elastic retainer 12 thereinto. By example and without limitation, the disks 32 are of a type commercially available as latex sealing disks commonly used for sealing balloons.

According to the embodiment of FIG. 4, the anchors 14, 16 are different mechanical crimp-on clips 36, 38, respectively. The mechanical crimp-on clip 36 at a first end 40 of the elastic retainer 12 is formed as thin-shell hollow ball made of a pliable metal such as tin or aluminum and having a plurality of formable teeth 42. The teeth 42 are originally spread to form an open mouth into the interior of the hollow ball 36. The first end 40 of the elastic retainer 12, i.e., the portion that forms the tail 18 in FIGS. 1 and 3, is fed through the open mouth into the interior of the hollow ball 36. Then the teeth 42 are pressed together, i.e., crimped, to close the mouth around the end 40 of the elastic retainer 12, thereby forming the anchor 14 that is too large to pass through the slot 28 in the end portion 24 of the support bar 22.

In FIG. 4 the mechanical crimp-on clip 38 at a second end 44 of the elastic retainer 12 is formed as thin-shell hollow tube made of a pliable metal such as tin or aluminum and having a pair of formable lips 46 that are optionally formed with small teeth. The formable lips 46 are formed as a slit extending part of the length of the tubular clip 38. The lips 46 of the slit are originally spread to form an open mouth into the interior of the hollow tube 38. The second end 44 of the elastic retainer 12, i.e., the portion that forms the tail 20 in FIGS. 1 and 3, is fed through the open mouth into the interior of the hollow tube 38. Then the lips 46, and teeth if present, are pressed together, i.e., crimped, to close the mouth around the end 44 of the elastic retainer 12, thereby forming the anchor 16 that is too large to pass through the slot 30 in the end portion 26 of the support bar 22.

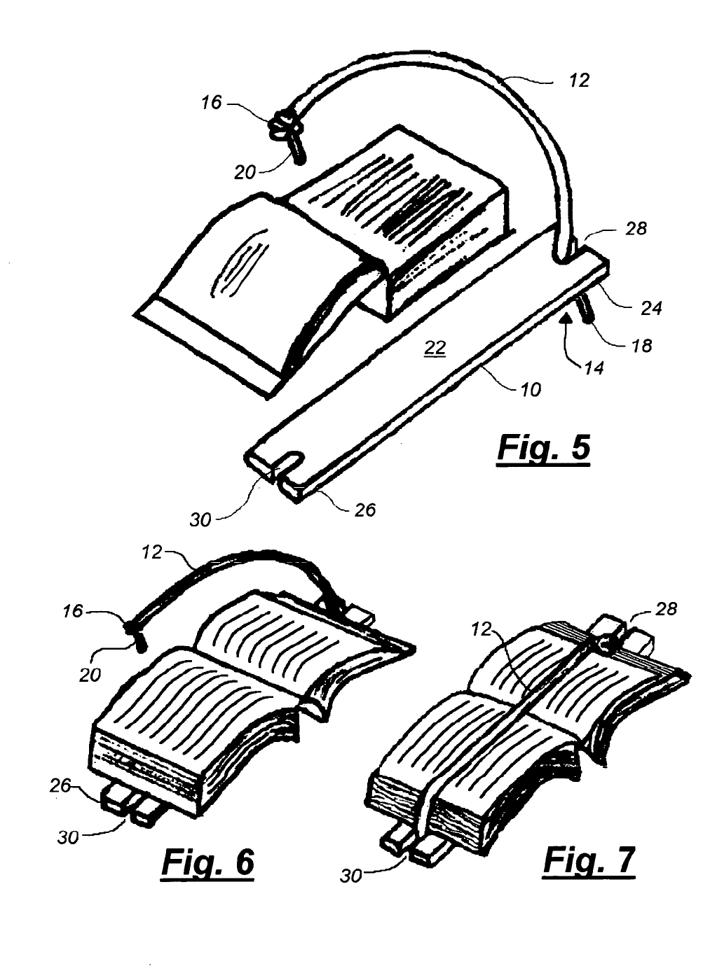

FIG. 5, FIG. 6, and FIG. 7 together illustrate initial installation of the book page holder of the invention. FIG. 5 illustrates preparation of the book page holder wherein the elastic retainer 12 is fitted through the slot 28 in one end 24 of the support bar 22 with the corresponding anchor 14 and tail 18 on a backside or bottom side of the support bar 22 opposite from the main body of elastic retainer 12. In FIG. 6 the support bar 22 is positioned under an open book. As described herein, the support bar 22 is in length at least the width of an open book with an additional length at both ends of the support bar 22 wherein the anchors 14, 16 and respective tails 18, 20 of the elastic retainer 12 are captured. The anchor 16 and tail 20 are grasped and drawn across the width of the pages and covers of the open book while simultaneously the body of the elastic retainer 12 is resiliently stretched between the anchors 14, 16. In FIG. 7 the stretched body of the elastic retainer 12 is laid against the open pages of the book while the elastic retainer 12 is fitted through the second slot 30 in the second end 26 of the support bar 22 with the corresponding anchor 16 and tail 20 on a backside or bottom side of the support bar 22 opposite from the main body of elastic retainer 12. The anchors 14, 16 in the respective slots 28, 30 hold the elastic retainer 12 taut across the book. The tension in the elastic retainer 12 thereby holds the pages down flat on the book so the material printed on the pages of the book can be read or examined while the reader's hands are free for other uses, such as taking notes, with both hands while continuing reading. The tension in the elastic retainer 12 is, however, light enough to permit the body of the elastic retainer 12 to be raised off the book sufficiently to turn one or more pages of the book forward or back.

The pages of the book are turned by grasping and lifting the elastic retainer 12 at or near its center, and with the pressure against the pages thus relieved, turning the pages. The elastic retainer 12 is released when the desired pages are presented, and the tension in the elastic retainer 12 again holds the pages down flat on the book so the material printed on the pages of the book can be read or examined with the reader's hands free.

Alternatively, a book in an initially closed state is installed into the book page holder of the invention as illustrated in FIG. 7 by being slipped between the installed elastic retainer 12 of the assembled book page holder having the elastic retainer 12 stretched between the slots 28, 30 with the anchors 14, 16 and respective tails 18, 20 on the backside or bottom side of the support bar 22. The previously installed elastic retainer 12 is grasped and lifted at or near its center, and with the pressure against the support bar 22 thus relieved, the closed book is slipped between the elastic retainer 12 and support bar 22. The cover of the book is opened by raising the elastic retainer 12 with one hand and turning the book cover open, the pages are laid flat and substantially parallel to the support bar 22 using the other hand. Additional page are turned in a manner described herein.

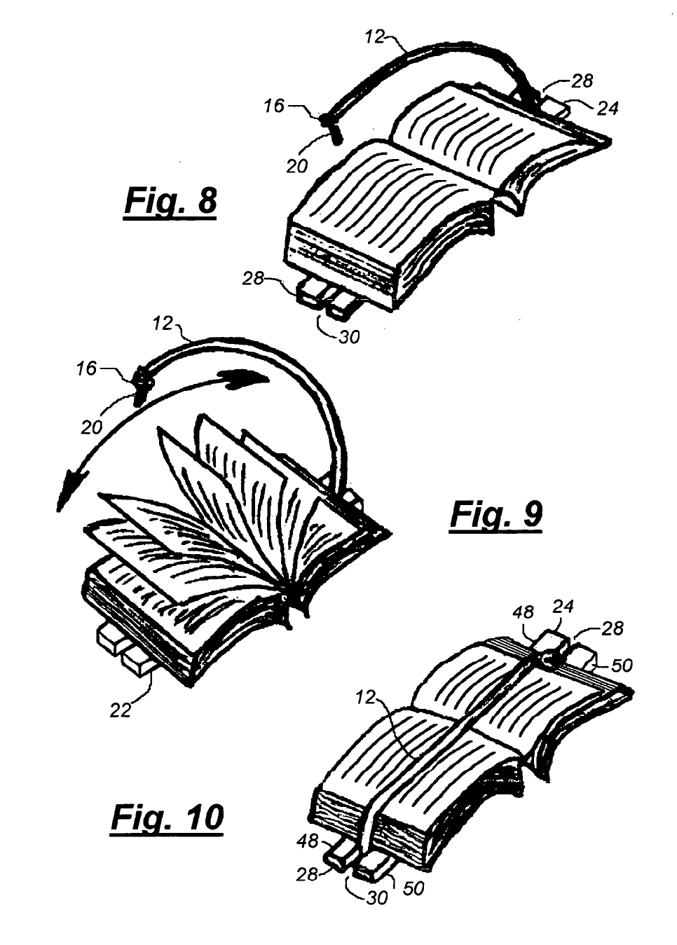

FIG. 8, FIG. 9 and FIG. 10 illustrate an alternative method of turning pages while using the book page holder of the invention. Accordingly, as illustrated in FIG. 8, when the pages of the book are to be turned, the elastic retainer 12 is released from the support bar 22 at one end 26 (or 24) by sliding the body of the elastic retainer 12 out of the slot 30 (or 28), whereby the anchor 16 (or 14) is released from the backside or bottom side of the support bar 22. As illustrated in FIG. 9, without removing the book from the support bar 22, the pages are turned to the desire place in the book, as indicated by the arrow. As illustrated in FIG. 10, when the desired place is found in the book, the anchor 16 (or 14) and tail 20 (or 18) are drawn again across the width of the pages and covers of the open book while simultaneously the body of the elastic retainer 12 is again resiliently stretched between the anchors 14, 16. The stretched body of the elastic retainer 12 is again laid against the open pages of the book while the elastic retainer 12 is again fitted through the slot 30 (or 28) in the end 26 (or 24) of the support bar 22 with the corresponding anchor 16 (or 14) and tail 20 (or 18) again on a backside or bottom side of the support bar 22 opposite from the main body of elastic retainer 12. The anchors 14, 16 in the respective slots 28, 30 again hold the elastic retainer 12 taut across the open pages of the book.

The elastic retainer 12 will cover a portion of the writing, pictures, diagrams or other material in the book at times when holding the book open. With reference to FIG. 10, the book is moved up to expose the writing under the elastic retainer 12 by placing the fingers of each hand on an upper edge 48 of the support bar 22 and pushing an the bottom edge of the book up with both thumbs. The book is moved down to expose the material under the elastic retainer 12 by placing the thumbs of each hand on a lower edge 50 of the bar and pushing the top of the book down with the fingers of both hands.

The book is removed from the book page holder 10 by extended pushing of the book up (or down) relative to the lower edge 50 (or upper edge 48) until the book passes beyond the confines of the elastic retainer 12.

Alternatively, the book is removed from the book page holder 10 by raising the elastic retainer 12 with one hand while removing the book from between the elastic retainer 12 and support bar 22 with the other.

According to another alternative removal method, the book is removed from the book page holder 10 by unhooking the anchor 14 (or 16) from the slot 28 (or 30) and thereby releasing the tension in the elastic retainer 12. The book is then lifted from the support bar 22.

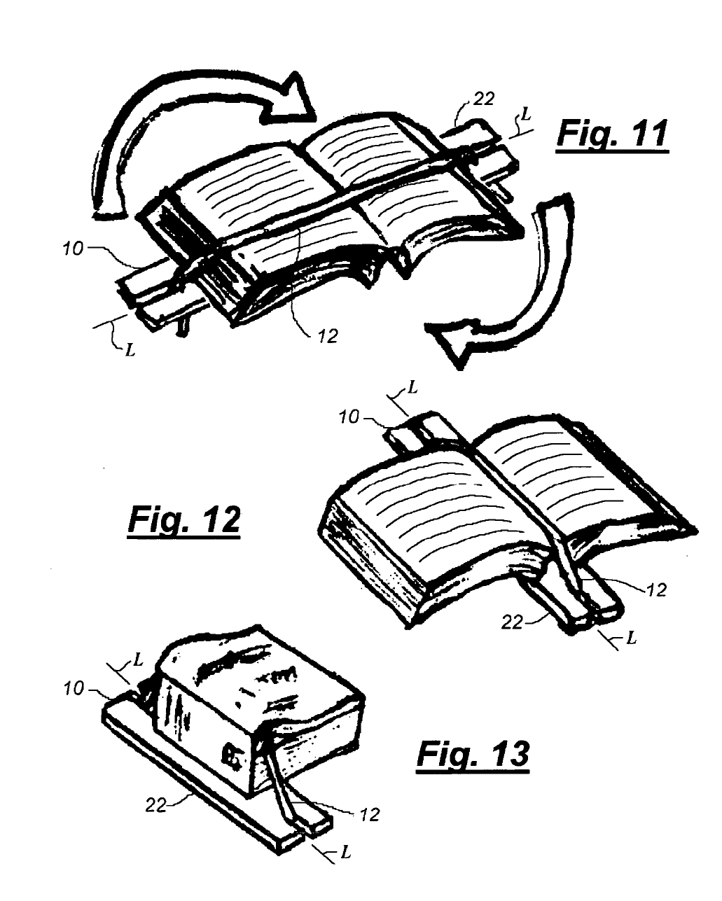

According to one embodiment of the invention, the book page holder 10 operates as a book mark when not in use holding the book open. FIGS. 11, 12 and 13 together illustrate operation of the book page holder of the invention for marking the reader's place in the book when not in use for holding the book open. As illustrated in FIG. 11, to mark the reader's place in the book, without unhooking the anchors 14, 16 from the support bar slots 28, 30, the reader turns the book relative to the elastic retainer 12 and support bar 22, as indicated by the arrows. As illustrated in FIG. 12, the book is rotated relative to the book page holder 10 to align the book's spine with the longitudinal axis L of support bar 22. The still anchored elastic retainer 12 stays with and follows the support bar 22 and is also aligned with the book spine but is still over the pages. The support bar 22 and elastic retainer 12 are then maneuvered, with the body of the elastic retainer 12 slipping across the page, to position the still anchored body of the elastic retainer 12 in the valley between the two opposing pages of the still open book. The support bar 22 is simultaneously positioned proximate to the spine. As illustrated in FIG. 13, the book is closed with the support bar 22 proximate to the spine and the elastic retainer 12 captured between the pages at the place the reader closed the book. To resume reading at the same place, the reader opens the book flat at the place marked by the elastic retainer 12 and turns the support bar 22 with the still anchored elastic retainer 12 crosswise to the book's spine. The still anchored elastic retainer 12 is automatically positioned to hold the pages open at the place where the reader earlier left off reading. The book page holder 10 is thereafter operated as discussed herein.

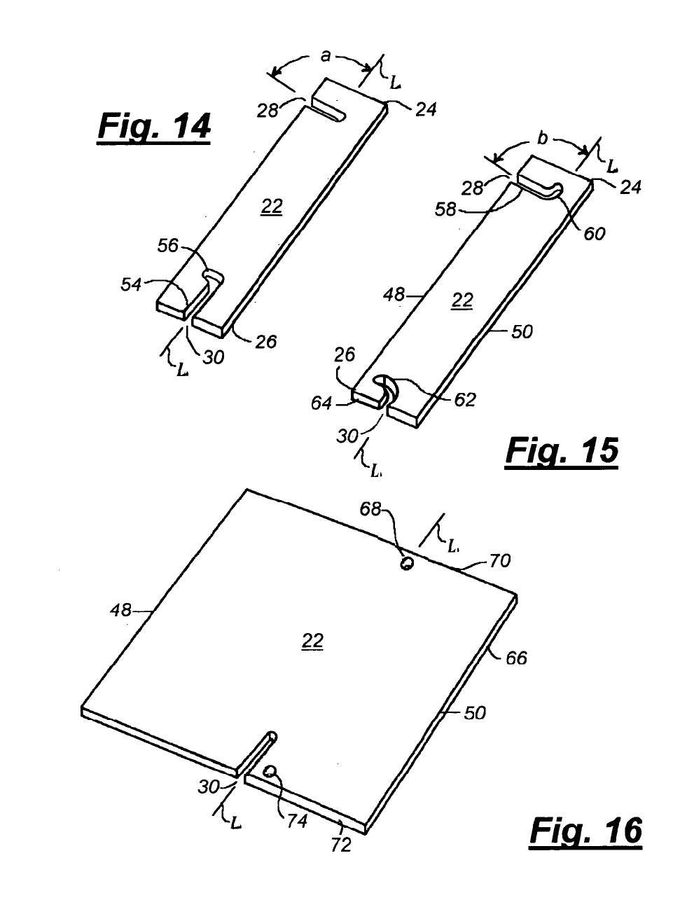

FIG. 14, FIG. 15 and FIG. 16 each illustrate one or more alternative embodiments of the support bar 22 of the book page holder 10 of the invention. FIG. 14 illustrates the support bar 22 embodied as an elongated substantially rectangular bar having different slots formed through the substrate thickness of each of the first and second end portions 24, 26. According to one embodiment of the invention, one or both of the slots 28, 30 are optionally embodied as shown by the alternative slot 28 in the first end 24 of the support bar 22 that is oriented at an angle a relative to the longitudinal axis L. For example, the angle a is any angle between 0 and about 90 degrees so that the slot 28 is oriented any where between parallel and crosswise to the support bar's longitudinal axis L. This alternative angular orientation of one or both of the slots 28, 30 operates as a locking means that aids in retaining the elastic retainer 12 during use.

Alternatively, one or both of the slots 28, 30 are optionally embodied as shown by the alternative dog-leg slot 30 in the second end 26 of the support bar 22 that includes a first portion 54 that extends substantially along the longitudinal axis L and ends within the interior of the support bar 22 in second leg portion 56 of the dog-leg slot 30 that is angled away from the first slot portion 54. This alternative dog-leg configuration of one or both of the slots 28, 30 operates as a locking means that aids in retaining the elastic retainer 12 during use.

FIG. 15 illustrates the slot 28 in the first end 24 of the support bar 22 configured as another dog-leg slot having a first portion 58 that is oriented at an angle b relative to the support bar's longitudinal axis L. For example, the angle a is any angle between 0 and about 90 degrees so that the first portion 58 of the slot 28 (or 30) is oriented any where between parallel and crosswise to the support bar's longitudinal axis L. The dog-leg slot 28 (or 30) also includes a second leg portion 60 that is angled away from the first slot portion 58 and may lead toward the outer end 24 (or 26) of the support bar 22. This alternative dog-leg configuration of one or both of the slots 28, 30 operates as a locking means that aids in retaining the elastic retainer 12 during use.

FIG. 15 illustrates yet another alternative embodiment of the slots 28, 30. For example, one or both of the slots 28, 30 (shown) is embodied having a curvilinear slot portion 62 that curves into the interior of the support bar 22 from either upper or lower edge 48, 50 or the end edge 64 that is crosswise to the longitudinal axis L. This alternative curvilinear configuration of one or both of the slots 28, 30 operates as a locking means that aids in retaining the elastic retainer 12 during use.

FIG. 16 illustrates yet another alternative embodiment of the invention wherein the support bar 22 is configured as a substantially rigid plate 66 formed of plastic or Plexiglas, acrylic, wood, metal, or another suitably stiff material. Alternatively, the rigidity of the support bar 22 is supplied by conventional stiffening shapes formed in a thin sheet of plastic or other formable material. The plate 66 is configured in the general shape of an open book and is sized, by example and without limitation, slightly larger than an open standard sized hard cover book with the slots 28, 30 provided in the extra space on either side of the plate 66 as described herein for the slots 28, 30 in the respective ends 24, 26 of the rectangular configuration of the support bar 22 shown in earlier figures. Alternatively, the plate 66 is sized slightly larger than an open standard sized paperback book and is optionally longer as measured crosswise to the longitudinal axis L, whereby the upper and lower edges 48, 50 are spaced apart about twice the height of either a standard sized hard cover book or a standard sized paperback book. According to the embodiment of FIG. 16, the book can be pushed above or below the centrally located slots 28, 30, and by extension the elastic retainer 12, without leaving the surface of the plate 66 that operates as the support bar 22. This embodiment of the support bar 22 provides more convenient handling of the book page holder 10 during installation of the book and subsequent turning of the pages.

FIG. 16 also illustrates another embodiment of the means for anchoring the elastic retainer 12, which is omitted here for clarity. For example, a first one of the slots 28 (or 30) is replaced by a passage 68 formed, by example and without limitation, as an aperture formed through the thickness of the substrate of which the plate 66 is fabricated near a first edge 70. A first one of the tails 18 (or 20) of the elastic retainer 12, as shown in earlier figures, is fed through the aperture 68 and a first of the anchoring means 14 (or 16) is applied thereto. The second anchoring means 16 (or 14) is applied to the opposite end of the elastic retainer 12 so that the main body of the elastic retainer 12 is thereby substantially permanently captured in the aperture 68 between the first and second anchors 14, 16. According to one embodiment of the invention, the second slot 30 (or 28) is provided adjacent to a second opposite edge 72 of the plate 66. The book page holder 10 of the invention is thereafter operable and operated as described herein in regard to the embodiments illustrated in earlier figures.

According to another alternative embodiment of the invention, the slot 30 (or 28) is replaced by a passage 74 formed as a second through aperture that is provided adjacent to the second opposite edge 72 of the plate 66. When the second aperture 74 is thus provided in place of the slot 30 (or 28), the second one of the tails 20 (or 18) of the elastic retainer 12, as shown in earlier figures, is fed through the second aperture 74 and a second of the anchoring means 16 (or 14) is applied thereto. The elastic retainer 12 is thereby substantially permanently anchored to the plate 66 that operates as the support bar 22. According to such embodiment, the book page holder 10 is operated as described herein for operation without unhooking the anchors 14, 16 from the respective slots 28, 30 so that the tension in the elastic retainer 12 is not released except as grasped and manipulated by the user.

FIG. 17 is a plan view that illustrates another alternative embodiment of the book page holder invention, wherein the support bar 22 is an elongated bar formed with beveled or rounded (shown) ears 76, 78 adjacent each of its first and second ends 24, 26 and having passages 80, 82 formed as wide-mouthed slots or necked-down areas between the respective ears 76, 78 and a main body portion 84. The necked-down passages 80, 82 are spaced apart by the distance D that is discussed in regard to earlier figures. The means for anchoring the elastic retainer 12 is provided by loops 86, 88 formed in the opposite ends of the elastic retainer 12 that are fitted over the respective ears 76, 78 and into the respective wide-mouthed slots 80, 82.

Optionally, the first and second ends 24, 26 of the elongated support bar 22 are each formed with a notch 90 between the ears 76, 78 and the loops 86, 88 of the elastic retainer 12 are extended from the wide-mouthed slots 80, 82 over the notches 90, which aids in maintaining the position of the elastic retainer 12 near the centerline of the support bar 22.

FIG. 18 illustrates another alternative embodiment of the book page holder invention wherein the support bar 22 is an elongated bar formed with a small notch or indentation 92 in at least one end 24 (or 26) structured to accommodate the anchor 14 structured as a hook having a curved jaw 94 led to a tail 96 coiled tightly about one end 40 (or 44) adjacent the tail 18 (or 20) of the elastic retainer 12. The curved jaw 94 of the hook anchor 14 is structured to fit around the body of the support bar 22 while fitting within the notch 92. The curved jaw 94 is, by example and without limitation, turned almost completely back on itself in a tight curve similar to a safety pin, whereby the jaw 94 resists dislodging strains on the anchor 14 applied in almost any direction. Accordingly, the hook anchor 14 can only be dislodged by stretching the elastic retainer 12 by pulling the hook anchor 14 substantially straight away from the support bar 22 along its length or longitudinal axis, as indicated by the first arrow a1. The hook anchor 14 thus maintains the hold of the book page holder 10 against the strains exerted by a book inserted therein as described herein.

FIG. 18 also illustrates another alternative embodiment of the invention wherein at least one of the slots 30 (or 28) is sized more narrow than the body of the elastic retainer 12 so as to crimp one end 44 (or 40) of the body thereof when it is pressed into the slot 30 (or 28). The tail portion 20 (or 18) is left on an opposite side of the support bar 22 from the elastic retainer 12. The elastic retainer anchoring means is thus provided by the slot 30 (or 28) formed in the support bar 22, whereby anchors 14, 16 are eliminated from the elastic retainer 12. The slot 30 (or 28) is formed with a radius in its closed end and a beveled lead-in formed at the entrance or open end where the slot 30 (or 28) communicates with the edge of the support bar 22. The useful length of the elastic retainer 12 is adjustable for accommodating books of different thickness by adjusting the position along the body of the elastic retainer 12 where it is pressed into the slot 30 (or 28), as indicated by the second arrow a2. The book page holder 10 of the invention is thereafter operable and operated as described herein in regard to the embodiments illustrated in earlier figures.

FIG. 19 illustrates the embodiment of the means for anchoring the elastic retainer 12 wherein a first one of the slots 28 (or 30) is replaced by the passage 68 formed, by example and without limitation, as an aperture formed through the thickness of the substrate of which the support bar 22 is fabricated near one end 24 (or 26). A first one of the tails 18 (or 20) of the elastic retainer 12, as shown in earlier figures, is fed through the aperture 68 and a first of the anchoring means 14 (or 16) is applied to the end 40 (or 44) of the elastic retainer 12. The second anchoring means 16 (or 14) is applied to the opposite end of the elastic retainer 12 so that the main body of the elastic retainer 12 is thereby substantially permanently captured in the aperture 68 between the first and second anchors 14, 16. Accordingly, the book page holder 10 of the invention is thereafter operable and operated as described herein in regard to the embodiments illustrated in earlier figures.

FIG. 20 illustrates yet another embodiment of the book page holder of the invention wherein the anchoring means 14, 16 are embodied as hook-shaped toothed edge-grippers having a curved jaw 98 led back on itself and having a lip on its open mouth structured with one or more gripping members or “teeth” 100. The curved jaw 98 is structured to fit around the body of the support bar 22 at one end 24 (or 26) while the teeth 100 are structured to grip the underside of the bar 22 opposite from the elastic retainer 12. A tail portion 102 of the toothed anchoring means 14 (or 16) is structured to crimp onto the end 40 (or 44) of the elastic retainer 12. For example, the toothed anchoring means 14 (or 16) is made of a pliable metal such as tin or aluminum and the tail portion 102 of is formed having a pair of formable lips that are optionally formed with small teeth, similar to the mechanical crimp-on clips 36, 38 illustrated in FIG. 4 and described in detail herein. The formable lips are originally spread to form an open mouth into an interior of a hollow tube shaped in the tail portion 102. The end 40 (or 44) of the elastic retainer 12, i.e., the portion that forms the tail 18 (or 20) in FIGS. 1 and 3, is inserted into the open mouth into the interior of the hollow tube shape. Then the lips, and teeth if present, are pressed together, i.e., crimped, to close the mouth around the end 40 (or 44) of the elastic retainer 12, thereby forming the toothed anchoring means 14 (or 16) that is suitable for gripping the end portion 24 (or 26) of the support bar 22 and thereby securing the elastic retainer 12 thereto. The toothed anchoring means 14 (or 16) thus eliminate the slots 28, 30, apertures 68, 74 and notches 92 entirely from the ends 24, 26 of the support bar 22.

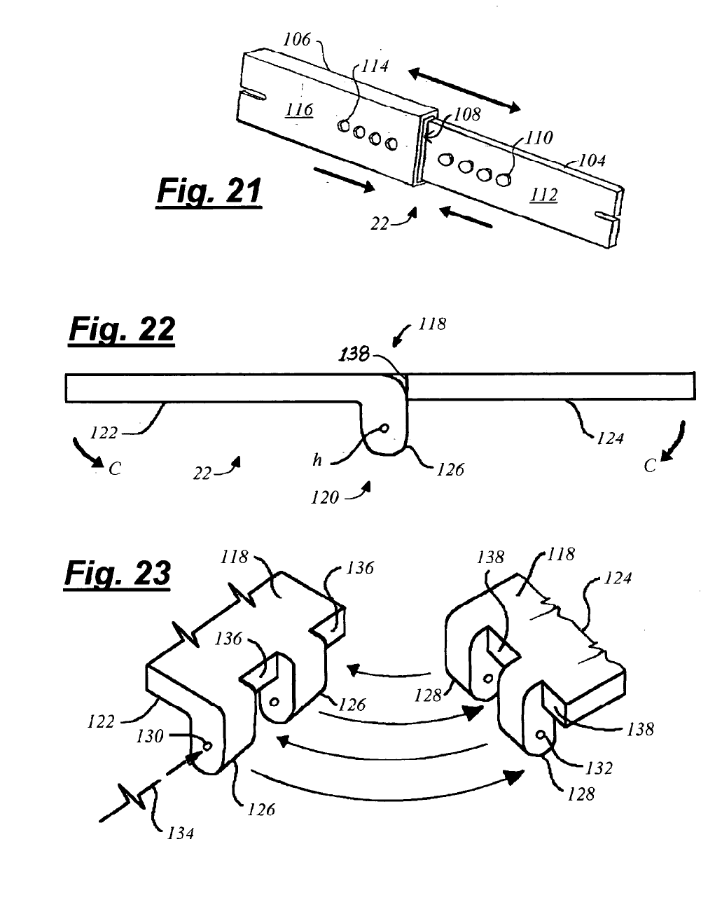

According to one or more other alternative embodiments of the invention, the book page holder 10 of the invention can be made more compact by a telescoping feature incorporated into the support bar 22. FIG. 21 illustrates by example and without limitation one exemplary embodiment of such a telescoping feature in which a first portion 104 of the telescoping support bar 22 is a thin, rigid and substantially flat elongated rectangular shape, and a second portion 106 of the telescoping support bar 22 is an elongated rectangular tube having a slot 108 formed at least partway therethrough and aligned with its longitudinal axis. The slot 108 is sized to slidingly accept the first portion 104 of the telescoping support bar 22 with the longitudinal axes of the first and second support bar portions 104, 106 substantially coincident. In other words, the relative sizes of the first portion 104 of the telescoping support bar 22 and the slot 108 in the second portion 106 are matched so that the first support bar portion 104 readily slides into the slot 108 in the second portion 106, as indicated by the two arrows shown in FIG. 21 beneath the support bar 22. Means for locking the first support bar portion 104 relative to the slot 108 in the second portion 106 is embodied, by example and without limitation, as one or more detents or “buttons” 110 projected above the planar surface 112 of the first support bar portion 104. Cooperating holes 114 are provided in one face 116 of the second support bar portion 106 and sized to accept the buttons 110 thereinto. The single button or multiple buttons 110 interconnects with the cooperating holes 114 and optionally interconnects in different combinations so that an overall length of the book page holder 10 of the invention is adjustable to a number of different lengths between a minimum compact size and a maximum length that is sized to accommodate a desired book size in its open condition, as described herein. Other locking means are also contemplated.

According to other alternative embodiments of the invention, the book page holder 10 of the invention can be made more compact by including a folding feature. FIG. 22 illustrates the folding book page holder 10 of the invention configured in an open and locked operating condition in which the hinged support bar 22 supports the open pages of a book on its substantially planar book support surface 118. As illustrated in FIG. 22 and FIG. 23, the support bar 22 of the book page holder 10 is provided with a hinge mechanism 120 positioned between first and second thin, rigid and substantially flat elongated rectangular shaped partial support bars 122, 124. The hinge mechanism 120 preferably permits the two hinged partial support bars 122, 124 to rotate about a hinge point h that is offset relative to the main bodies of the two partial support bars 122, 124. For example, the hinge mechanism 120 is structured in a plurality of matching dog-leg portions 126, 128 (best shown in FIG. 23) projected at the inner ends of the two partial support bars 122, 124. The hinge mechanism 120 thereby permits the two hinged partial support bars 122, 124 to swing toward one another, as indicated by the arrows C, C, from the open condition (shown) in which the book page holder 10 operates.

FIG. 23 illustrates the folding support bar 22 of the book page holder 10 embodied, by example and without limitation, having the hinge mechanism 120 structured as one or a plurality of the matching dog-leg portions 126, 128 projected at the inner ends of the two partial support bars 122, 124. Matching hinge pin receiving holes 130, 132 are provided through the dog-leg portions 126, 128 and offset from the main bodies of the two partial support bars 122, 124. The matching dog-leg hinge portions 126, 128 of the two partial support bars 122, 124 are received into matching slots formed between the dog-leg hinge portions 126, 128 of the opposite partial support bar 124, 122. A hinge pin 134 press fitted through the hinge pin receiving holes 130, 132 permits the two partial support bars 122, 124 to fold against one another in a compact closed condition with their non-operational back surfaces opposite the book support surfaces 118 touching. In an open operational condition, bearing surfaces 136, 138 at the bases of the slots between the respective dog-leg portions 126, 128 act as mechanical stops against which the dog-leg portions 126, 128 of the opposite partial support bars 122, 124 rest to arrest the rotation between the partial support bars 122, 124 and lock them in the open condition illustrated in FIG. 22 when the spring tension of the elastic retainer 12 is applied therebetween.

While the preferred embodiment of the invention has been illustrated and described, it will be appreciated that various changes can be made therein, including combinations of the different illustrated and described alternative embodiments of the invention, without departing from the spirit and scope of the invention.

What is claimed is:

1. A book page holder device comprising:
a substantially thin, flat and rigid support member having first and second spaced apart edges; and
an elastic retaining means having means for anchoring first and second opposite ends thereof adjacent the respective first and second spaced apart edges of the support member.

2. The device of claim 1 wherein the anchoring means further comprises one or more hook-shaped mechanical edge gripper secured to the elastic retaining means.

3. The device of claim 1 wherein the elastic retaining means further comprises a fabric-covered elastic material having the anchoring means formed at first and second opposite ends thereof.

4. The device of claim 1 wherein the support member further comprises a substantially rigid material.

5. The device of claim 1 wherein the support member further comprises first and second passages through the support member adjacent the first and second spaced apart edges with the passages being sized to accept the elastic retaining means therethrough and to reject the anchoring means from entering thereinto and being spaced apart farther than a distance between the anchoring means when the elastic retaining means is in a relaxed state.

6. The device of claim 5 wherein one or more of the first and second passages is a slot communicating with an edge of the support member.

7. The device of claim 5 wherein one or more of the first and second passages is an aperture adjacent to an edge of the support member and communicating between opposite surfaces thereof.

8. The device of claim 5 wherein the anchoring means further comprises one of one or more loops formed in the elastic retaining means, one or more knots formed in the elastic retaining means, one or more mechanical clips each having a slot formed therein sized more narrow than the elastic retaining means, one or more hooks each secured to the elastic retaining means, and one or more mechanical crimp-on clips each having a pliable portion crimped onto the elastic retaining means.

9. A book page holder device for holding open the pages of a book, the book page holder device comprising:
a substantially flat and rigid support member sized wider than one of a standard sized hard cover and a standard sized paperback book in an open state and being formed with two opposing edges spaced apart across the width of the support member a distance that is approximately a width of one of a standard sized hard cover and a standard sized paperback book in an open state; and
an elongated resilient elastic retainer structured to extend between the two spaced-apart edges and having first and second anchors provided adjacent to respective first and second opposite ends thereof, the anchors being structured to secure the first and second opposite ends of the elastic retainer adjacent to the respective spaced-apart edges of the support member.

10. The book page holder device of claim 9 wherein the support member is formed of an elongated bar having at least one passage positioned adjacent to one of the first and second ends of the elongated bar;
the elastic retainer is further structured to pass through the passage; and
at least one of the anchors is further structured to be unable to pass through the passage.

11. The book page holder device of claim 10 wherein the support member further comprises at least two spaced-apart passages adjacent the respective opposing edges, and wherein at least one of the two spaced-apart passages further comprises a slot through a thickness of the support member and communicating with an edge thereof.

12. The book page holder device of claim 10 wherein the support member further comprises at least two spaced-apart passages adjacent the respective opposing edges, and wherein at least one of the two spaced-apart passages further comprises an aperture formed through a thickness of the support member and positioned adjacent an edge thereof.

13. The book page holder device of claim 9 wherein the support member is formed of a material selected from the group of materials consisting of plastic, Plexiglas, acrylic, wood, and metal.

14. The book page holder device of claim 9 wherein the support member is formed of a rectangular plate including the two spaced-apart edges.

15. The book page holder device of claim 9 wherein the elastic retainer further comprises an elastic material having a slippery contact surface and having the anchoring means formed at first and second opposite ends thereof.

16. The book page holder device of claim 15 wherein the first and second anchors further comprise an anchor selected from the group of anchors consisting of a loop, a knot, a hook, a slip-on clip, and a crimp-on clip.

17. The book page holder device of claim 15 wherein elastic retainer further comprises a plurality of the anchoring means formed at one of the first and second opposite ends thereof.

18. The book page holder device of claim 9 wherein the support member further comprises means for compacting the support member.

19. 18 wherein the means for compacting the support member further comprises one of means for telescoping a first portion of the support member relative to a second portion thereof, and means for folding the first portion of the support member relative to the second portion thereof.

20. A book page holder device, comprising:
a substantially rigid elongated support bar sized to accommodate an open book and having first and second ends thereof being spaced apart far enough to position the open book therebetween with the first and second ends extending beyond the extents of the open book; and
an elongated resilient elastic retainer having first and second ends anchored to the first and second ends of the support bar adjacent the first and second ends thereof with at least one of the first and second ends of the elastic retainer being releasably so anchored, the elastic retainer being in tension when so anchored to the support bar.

21. The device of claim 20 wherein the elastic retainer further comprises anchors on each of its first and second ends.

22. The device of claim 21 wherein the support bar further comprises a passage formed as a slot communicating with a first edge portion of the support bar adjacent the first end thereof, and one of the anchors further comprises one of a loop formed in the elastic retainer, a knot formed in the elastic retainer, a hook secured to the elastic retainer, a slip-on clip secured to the elastic retainer, and a crimp-on clip secured to the elastic retainer.

23. The device of claim 22 wherein a second one of the passages is formed as an aperture passing through the support bar.

24. The device of claim 23 wherein the support bar further comprises a second passage formed as a second slot communicating with a second edge portion of the support bar adjacent the second end thereof.
